(19) United States
(12) Patent Application Publication
(10) Pub. No.: US 2021/0163042 A1
(43) Pub. Date: Jun. 3, 2021

(54) METHOD FOR STOPPING A SELF-DRIVING VEHICLE

(71) Applicant: Volkswagen Aktiengesellschaft, Wolfsburg (DE)

(72) Inventors: Floris van de Klashorst, Wolfsburg (DE); Peter Mirwaldt, Braunschweig (DE); Marcel Günther Penz, Berlin (DE)

(21) Appl. No.: 17/102,198

(22) Filed: Nov. 23, 2020

(30) Foreign Application Priority Data
Nov. 27, 2019 (DE) 102019218411.1

(51) Int. Cl. B60W 60/00; B60W 30/09; B60W 30/095; B60W 50/14

(52) U.S. Cl. CPC B60W 60/0027; B60W 30/09; B60W 30/0956; B60W 50/14; B60W 2554/4041; B60W 2554/4042; G05D 1/021; B60W 2720/10; B60W 2720/12; B60W 2554/4044; B60W 2540/049; B60W 2554/4029; B60W 2554/4043

(57) ABSTRACT

The invention relates to a method for stopping a self-driving vehicle (10), starting with determining an approach of the vehicle (10) to a specified stopping point (83). In addition, at least one moving object (70) is detected within the environment of the vehicle. A projected trajectory (84) of the vehicle (10) and a projected trajectory (85) of the object (70) at a first point in time t₁ are determined. Based on the projected trajectory (84) of the vehicle (10), a second point in time t₂ is then determined, at which the vehicle (10) arrives at the specified stopping point (83). Based on the position and speed of the object (70) at the second point in time t₂ determined on the basis of the projected trajectory (85) of the object (70), a collision probability between the object (70) and a door (15) or a passenger of the vehicle (10) at the specified stopping point (83) at the second point in time t₂ is determined. Lastly, a third point in time t₃ is determined for opening at least one door (15) of the vehicle (10), in order to minimize the determined collision probability. The invention also relates to a self-driving vehicle for executing the method according to the invention.

### RELATED APPLICATIONS

The present application claims priority to German Patent Application No. DE 102019218411.1 to van de Klashorst et al., titled “Method for Stopping a Self-Driving Vehicle”, filed Nov. 27, 2019, the contents of which is incorporated by reference in its entirety herein.

### BACKGROUND

The present disclosure relates to a method for stopping a self-driving vehicle, that enables an improved boarding and exiting the vehicle by passengers. A further aspect of the present disclosure relates to a self-driving vehicle configured to execute the technologies and techniques according to the present disclosure.

Current vehicles already have numerous assistance systems that assist drivers in a computer-based manner in numerous driving situations. These assistance systems can access sensors for obtaining measurement data that substantially surpasses the sensory capabilities of humans. In addition, the speed of these assistance systems significantly exceeds human reaction times. Known driver assistance systems include, e.g., lane keeping assistance, braking assistance when pedestrians are detected, and adaptive cruise control, in particular in heavy traffic.

By using such assistance systems, the autonomy of the driver with respect to driving decisions is increasingly transferred to the vehicle, or these operating control units. The ultimate result of this development will be a self-driving vehicle, which can maneuver entirely without human intervention. Fully automated passenger transportation can be obtained with such a self-driving vehicle.

Such self-driving passenger transportation will result in numerous mobility concepts, in particular in urban metropolitan areas. This is based on known ride hailing concepts, in which numerous users access vehicles in a vehicle fleet for limited periods of time, independently of one another. In that the vehicles are only associated with a specific user for the time they are actually in use, the unused time when the vehicle is parked can be minimized. This concept can also be supplemented with so-called ride pooling, in which numerous passengers share a vehicle, at least for parts of the respective route.

The concepts have the potential of significantly reducing the total number of necessary vehicles, thus making a positive contribution to environmental protection.

With a combination of the aforementioned mobility concepts with self-driving vehicles, in addition to the actual driving tasks other functions become available, without requiring action on the part of a human driver. In addition to storing baggage, directing nonlocal passengers to intermediate and/or target destinations also belong to these functions, as well as enabling a safe boarding and exiting for the passengers. The passengers are no longer assisted by a driver during these procedures, who might first exit the vehicle, for example, to hold the door open for the passengers. As such, the passengers are exposed to greater danger when boarding and exiting.

Methods for assisting passengers when boarding and exiting non-self-driving vehicles are known from the prior art, in particular for preventing collisions between other road users and the passengers. A common feature of these methods is that they are executed by a stationary vehicle, or linked to a standstill of the vehicle or its arrival at a target destination. According to these methods, arrival at predetermined target destination is always a prerequisite for executing the remaining steps of the method.

The known methods are adequate for conventional vehicles, in which the driver is solely responsible for the decision regarding the actual stopping maneuver. These methods are disadvantageous for self-driving vehicles, however, because they may result in delays in boarding and exiting the vehicle at the target destination. With self-driving automobiles, this may mean that waiting times must be taken into consideration in the overall evaluation of the driving experience, thus potentially reducing customer satisfaction.

### BRIEF SUMMARY

Aspects of the present disclosure are therefore to overcome the disadvantages of the prior art, and provide an improved method for stopping a self-driving vehicle, which minimizes the waiting times for boarding and exiting passengers, thus contributing to the acceptance of self-driving vehicles.

Technologies and techniques are disclosed for stopping a self-driving vehicle, comprising determining the approach to a specified stopping point for the vehicle; detecting at least one moving object in an environment of the vehicle; determining a projected trajectory of the vehicle and a projected trajectory of the object at a first point in time t1; determining a second point in time t2 for the arrival of the vehicle at the specified stopping point based on the projected trajectory of the vehicle, and a position and speed of the object at the second point in time t2 based on the projected trajectory of the object; determining a collision probability between the object and a door or a passenger of the vehicle at the specified stopping point based on the position and speed of the object at the second point in time t2; and determining a third point in time t3 for opening at least one door of the vehicle based on the determined collision probability.

### BREIF DESCRIPTION OF THE DRAWINGS

The invention shall be explained below in exemplary embodiments, with reference to the associated drawings. Therein:

FIG. 1 shows a schematic illustration of a self-driving motor vehicle according to some aspects of the present disclosure;

FIGS. 2a, 2b and 2c show schematic illustrations of a self-driving motor vehicle and a further moving object at different points in time according to some aspects of the present disclosure.

FIG. 3 shows a schematic illustration of a self-driving motor vehicle and a further moving object at a third point in time according to some aspects of the present disclosure; and

FIGS. 4a and 4b show schematic illustrations of a self-driving motor vehicle and a further moving object at a third and fourth point in time according to some aspects of the present disclosure.

### DETAILED DESCRIPTION

In some examples, the present disclosure relates to technologies and techniques for stopping a self-driving vehicle, such as a self-driving motor vehicle, in the semiautomatic or fully automatic transportation of at least one passenger. The method comprises at least the steps described below. In a first step of the method according to the present disclosure, it may be determined that the vehicle may be approaching a specified stopping point for the vehicle. This specified stopping point for the vehicle is preferably a stopping point specified by a passenger of the vehicle. This specified stopping point is preferably input by the user via an input means, e.g. a user interface in the vehicle, or via a mobile end device connected to the vehicle. Furthermore, it is also possible for the user to alter the specified stopping point, even during the stopping procedure. This specified stopping point may also be a stopping point specified by a user who is not yet in the vehicle. This user determines the stopping point, e.g., by inputting it in a mobile end device, wherein this input may be transmitted via a network server for the vehicle. The at least one passenger is preferably located in the vehicle, and would like to exit the vehicle at the specified stop. Alternatively, the at least one passenger may want to board the vehicle at the specified stop.

After the initial step, at least one mobile object may be detected in the environment of the vehicle. Self-driving vehicles have numerous sensors for continuously monitoring the environment, e.g. lidar, radar, ultrasound sensors, optical sensors, etc. The distances between the vehicle and surrounding objects are basically continuously determined using these sensors. An identification of the surrounding objects likewise preferably takes place, e.g. through vehicle to vehicle communication or vehicle to X communication, by means of which other mobile vehicles can be distinguished from stationary objects. This object identification also preferably involves algorithms, e.g. based on artificial intelligence (algorithms for machine learning), in order to reliably identify bicyclists, for example, on the basis of their characteristic shape. This therefore represents a simple programming task for the person skilled in the art using the sensors and control units available in a self-driving vehicle for at least detecting a moving object located in the environment of the vehicle. The environment of the vehicle is particularly preferably defined thereby by a distance threshold. This distance threshold is preferably not isotropic in all spatial directions, but instead may be greater in the direction of travel, i.e. along a roadway, than in the lateral direction.

In some examples, a projected trajectory of the vehicle and a projected trajectory of the object at a first point in time t1 are also determined in the method according to the present disclosure. The vehicle uses information regarding the location and speed of the vehicle obtained at numerous points in time to extrapolate the trajectory of the vehicle for this. The vehicle also uses information regarding the location and speed of the object obtained at numerous points in time to extrapolate the trajectory of the object. The determination of the trajectories of vehicles and objects based on numerous measurement values regarding the position and speed of the vehicle/object and the extrapolation of these trajectories into the future, e.g. by means of transverse line methods, is within the abilities of the person skilled in the art.

A second time t2 may be determined on the basis of the determined projected trajectory of the vehicle in the method according to the present disclosure, at which the vehicle arrives at the specified stop. In other words, a specified stopping point may be determined for the vehicle. The position and speed of the object at the second time t2 may be then determined on the basis of this second point in time t2 and the determined projected trajectories of the object. In other words, the location and speed of the object may be determined at the specified stopping point for the vehicle. A probability of a collision between the object and a door and/or a passenger of the vehicle at the specified stopping point may be then determined on the basis of the position and speed of the object at the second point in time t2. A predefined opening range for the vehicle door and/or a predefined exiting region for a passenger, for example, are also assumed for the position of the vehicle. This opening range and/or exiting region is preferably defined as an arc segment on the exterior of the vehicle. A shortest connection between a position of the vehicle and a nearby footpath, etc. may be determined for a passenger, which comprises the trajectory of the passenger. A collision between an object and a passenger is then preferably defined as an intersection of the trajectory of the object and this arc segment, or an intersection of the trajectories of the object and the pedestrian.

A collision probability may be obtained when an intersection of the object trajectory and the arc segment (relating to the door) or an intersection of the trajectories of an object and a pedestrian are determined. Uncertainties in the predicted trajectory of the object in relation to the specified stopping point at time t2 and relating to the behavior of the passenger are preferably taken into account in determining the collision probability. In other words, these values are varied within predetermined ranges and it may be determined whether one of the intersections defined above applies for each of the varied values. A numerical value may be determined for the risk of a collision between the object and door or passenger based on the number of varied values for which an intersection, i.e. a collision, may be determined.

A third time t3 may be then determined in the vehicle according to the present disclosure based on the determined collision probability, at which at least one door of the vehicle is opened in order to allow a passenger to board or exit. In other words, a time t3 may be determined at which it is possible to safely board or exit, e.g., without the risk of a collision with the object. In other words, a third time t3 may be determined at which the collision probability is at a minimum. Such configurations make it possible to already determine a safe point in time for boarding and exiting while a self-driving vehicle is underway. Determination of the point in time while the vehicle is traveling advantageously enables a particularly user-friendly coordination of the boarding and exiting process, as shall be described in greater detail below. In particular, the boarding and exiting can be coordinated such that a passenger will not notice any delays due to a passenger in the interior of the vehicle being unable to open a blocked door. This prevents the passenger for feeling locked in. Furthermore, the time in which the vehicle is stopped, e.g. in no-parking zones, can be advantageously minimized.

In some examples, if the collision probability exceeds a predetermined threshold value, a collision between the object and a door or a passenger of the vehicle is probable. According to this embodiment, a third time t3 is preferably determined that differs from the second time t2. In other words, the doors are not opened at the specified stopping time t2, but at a different point in time t3. The at least one door is preferably opened automatically by a correspondingly regulated mechanism in the self-driving vehicle. Alternatively, the door is opened by outputting the third time t3 to the passenger, such that the passenger can open the door at this time t3.

In some examples, an alternative stopping point may be determined within a predetermined tolerance for the specified stopping point. The tolerance is preferably selected such that a passenger or user inside the vehicle, who has called the vehicle, will only have to walk a short distance, and not cross the street. According to this embodiment, the vehicle then stops at the alternative stopping point at the third point in time t3. In other words, the determined actual stopping time t3 according to this embodiment corresponds to a different, alternative stopping point. The alternative stopping point is then preferably sufficiently outside a projected trajectory of the object. This alternative stopping point is also preferably close to a projected trajectory of the object, which is at a distance, however, to the vehicle at the third point in time t3, which distance is greater than a predetermined threshold value. In other words, the alternative stopping point is preferably reached by executing an additional steering maneuver. The alternative stopping point is also preferably reached by driving more quickly along the existing trajectory, in order to increase the distance to a slow-moving object. A sufficient exit time for the passenger should be taken into account in increasing the distance to an object.

In some examples, the determined collision probability between the vehicle and the object exceeds a threshold value, and the actual third point in time t3 and the specified second point in time t2 are identical. According to this embodiment, a collision is prevented exclusively by altering the stopping point, thus stopping at the alternative stopping point. The determined collision probability between the vehicle and the object can also fall below a threshold value, such that the vehicle can stop at the specified stopping point and at the specified point in time, without endangering the passenger/user.

In some examples, the speed of the vehicle is adjusted if the collision probability exceeds a threshold value, and the third point in time t3 and the second point in time t2 differ. The vehicle also stops at the specified stopping point at the third point in time t3 according to this preferred embodiment. In other words, the specified stopping point is not altered according to this embodiment, but instead, only the point in time is altered. The vehicle is particularly preferably braked in its trajectory, in order to allow a nearby object to pass by the vehicle. If the user then exits the vehicle at the specified stop, the moving object has already passed, and there is no longer any danger of a collision. It has been shown to be the case that such a stopping behavior is found to be substantially more acceptable by users than stopping at the specified stopping point and locking the doors until the third point in time t3; in particular, the delay in boarding or exiting due to the potential collision with the object is less noticeable.

In some examples, a distance between the vehicle and the object at the third point in time t3 preferably exceeds a predetermined threshold value. This advantageously ensures that even unpredictable acceleration and/or steering maneuvers of the moving object will not result in a collision between the vehicle and the object. Furthermore, a distance between the vehicle and the object has preferably increased at the third point in time t3, such that the object has already passed the vehicle at the third point in time t3. The aforementioned conditions are likewise preferably already taken into account when determining the third point in time t3.

A fourth time t4, for closing the at least one door of the vehicle is likewise preferably determined in the method according to the present disclosure, wherein this fourth time t4 is also determined based on the projected trajectory of the moving object. In other words, a time window is determined between the third point in time t3 and the fourth point in time t4, during which it is possible to board or exit the vehicle without the risk of a collision with the object. If, for example, the vehicle is stopped at an alternative stopping point after accelerating the vehicle at time t3, which is at a sufficient distance to the object at this time (time t3), this sufficient distance may no longer exist at a fourth point in time t4, due to the continued movement of the object. The door must therefore be closed at time t4. Furthermore, information regarding the environment with respect to opening and closing the door is preferably provided in a multimodal manner via visual and/or acoustic notifications, as shall be explained in greater detail below.

At least one other moving object may also be detected within the environment of the stopping vehicle. The detection of this second object likewise takes place using the numerous sensors and control units built into the vehicle, as explained above. According to this example, a projected trajectory may also be determined for the second object, and the fourth point in time t4 is determined, alternatively or additionally, on the basis of the projected trajectory of the second object. As such, in a situation in which the distance to a first determined object has already increased at time t3, because the vehicle has passed it, there may be a risk posed by a newly arriving moving object. By closing the doors (automatically or manually, after request by a notification) at the fourth point in time t4, danger to the passengers from the other object is avoided.

In some examples, collision probabilities between the object and each of the numerous doors of the vehicle at the third point in time t3 are determined. The various doors are defined, e.g., by various arc segments on the outside of the vehicle. An expanded spatial model of the vehicle is also preferably used, by means of which the various doors are defined in various directions by arc segments. According to this embodiment, one of the numerous doors is preferably determined and opened at the third point in time t3 based on the determined collision probabilities. The selected door is preferably opened automatically by a mechanism for this in the self-driving vehicle, or by the user after a notification has been output to the user. According to this embodiment, boarding or exiting by the user through a particularly endangered door of the vehicle, e.g. facing toward the middle of the road, can preferably be prevented.

The number and/or characteristics of passengers of the vehicle is likewise preferably determined using the technologies and techniques described herein. According to some examples, the collision probability between the object and the at least one passenger of the vehicle at the specified stopping point is also determined on the basis of the number and/or characteristics of the passengers. In one example, a longer period of time for boarding and exiting the vehicle is assumed for a larger number of people, and the collision probability is adjusted accordingly (increased). The collision probability is likewise preferably increased for passengers who move slower than average due to injuries or other physical conditions (passengers in wheelchairs, or older, walking-impaired individuals). The same applies for people with children, dogs, or large items, who require more time to board. By taking the number and/or characteristics of passengers into account, the safety of the passengers is further increased when boarding and/or exiting.

In some examples, alternatively or additionally to an automatic opening or closing of the vehicle doors, a notification is issued to a passenger of the vehicle. According to one example, this notification may include information regarding the third point in time t3, the alternative stopping point, and/or at least one moving object in the environment of the vehicle. This informs the passenger of the maneuvering of the self-driving vehicle as well as dangers posed by other objects. It has been shown to be the case that warning notifications without specific contents are frequently ignored by users. According to this example, notifications relating to specific situations are issued to the passengers, which preferably inform them of the positions and speeds of approaching objects and/or of a safe time window between the points in time t3 and t4 for boarding or exiting the vehicle.

A number and/or characteristic of at least one passenger or user of the vehicle may also be determined. This characteristic can be, e.g. the age, health, mobility, or nationality of the passenger or user. According to one example, the notification is also preferably adapted on the basis of the number and/or characteristics of the at least one passenger or user. A preferred language may be determined on the basis of a passenger's input, and the notification is issued in this language accordingly. A visual impairment of a user can likewise be determined, and the notification is then issued acoustically.

The notification may be issued via a screen and/or loudspeaker located in the vehicle. This notification informs the passengers of a suitable point in time or timeframe for exiting, as well as approaching objects. The notification is also preferably issued via a screen located on the exterior of the vehicle, or other visual or acoustic interfaces. As a result, users not inside the vehicle can be informed of a suitable point in time, or timeframe, for boarding, as well as of approaching objects. The notification is also preferably projected in an environment of the vehicle to inform a user in the environment of the vehicle who has called the vehicle, for example.

The examples provided herein may be implemented by electronic elements or components (hardware), or firmware (ASIC), or realized by executing a suitable program (software). The examples disclosed herein may likewise be realized or implemented by a combination of hardware, firmware, and/or software. Individual components may be configured as separate integrated circuits to execute individual steps, or they are located on a shared integrated circuit. Individual components configured to execute individual steps are also preferably located on a (flexible) printed circuit board (FPCB/PCB), a tape carrier package (TCP), or some other substrate.

The individual steps of the methods disclosed herein may be configured as one or more processes that can run on one or more processors in one or more electronic computer devices, and are generated when one or more computer programs are executed. The computers are preferably configured to function with other components, e.g. a communication module and one or more sensors, in order to realize the functions described herein. The instructions of the computer programs are preferably stored in a memory, e.g. a RAM element. The computer programs can also be stored in non-volatile storage mediums, e.g. a flash memory.

It should be also clear to the person skilled in the art that the functions of numerous computers (data processing devices) can be combined, or combined in a single device, or that the function of one specific data processing device can be distributed among numerous devices in order to execute the steps of the method without deviating from the method according to the present disclosure described above.

Another aspect of the present disclosure relates to a self-driving vehicle, such as a motor vehicle configured for semiautomatic or fully automatic passenger transportation, which is configured to execute the method according to the present disclosure. The motor vehicle may include, but is not limited to, numerous first sensors configured for detecting at least one moving object in the environment of the vehicle. The first sensors may be configured to detect sensor signals relating to the environment of the vehicle. The motor vehicle may also include numerous second sensors for obtaining movement data relating to the vehicle. The second sensors may be configured to detect sensor signals relating to the vehicle itself. The motor vehicle also contains a communication module for communicating with another vehicle and/or mobile end device. The communication module is configured to receive information via a communication network. The communication module preferably contains a radio signal, mobile communications, WLAN, and/or Bluetooth transceiver, or a wireless communication device. The communication module is also preferably configured to receive danger signals from other vehicles in the environment, e.g., via a car-to-car communication network.

The motor vehicle according to the present disclosure may also include a first output means for issuing notifications to passengers in the vehicle interior and/or a second output means for issuing notifications to passengers outside the vehicle. The outputting means are preferably a screen, projectors, and/or loudspeakers in the interior and on the exterior of the vehicle. The motor vehicle also contains a driving system configured for autonomous driving of the motor vehicle. The driving system is preferably configured for autonomous lateral and longitudinal control of the vehicle. The motor vehicle also contains a control unit designed and configured to execute the method according to the present disclosure, which is configured in particular to control all of the aforementioned components for executing the method according to the present disclosure.

Another aspect of the present disclosure relates to a computer program that includes commands which cause a computer that executes the program, e.g. a control unit in a motor vehicle according to the present disclosure, to execute the method according to the present disclosure, in particular the steps: determining the approach of a specified stopping point for the vehicle; detecting at least one moving object in the environment of the vehicle; determining a projected trajectory of the vehicle and a projected trajectory of the object at a first time t1; determining a second point in time t2 for the arrival of the vehicle at the specified stopping point based on the projected trajectory of the vehicle, and determining a position and speed of the object at the second point in time t2 based on the projected trajectory of the object; determining a collision probability between the object and a door or a passenger of the vehicle at the specified stopping point, based on the position and speed of the object at the second point in time t2; and determining a third point in time t3 for opening at least one door of the vehicle based on the determined collision probability.

Another aspect of the present disclosure relates to a computer-readable storage medium, including commands, which cause a computer, e.g. a control unit in a motor vehicle according to the present disclosure, that executes them to execute the method according to the present disclosure, in particular the steps: determining the approach of a specified stopping point for the vehicle; detecting at least one moving object in the environment of the vehicle; determining a projected trajectory of the vehicle and a projected trajectory of the object at a first time t1; determining a second point in time t2 for the arrival of the vehicle at the specified stopping point, based on the projected trajectory of the vehicle, and a position and speed of the object at the second point in time t2, based on the projected trajectory of the object; determining a collision probability between the object and a door or a passenger of the vehicle at the specified stopping point, based on the position and speed of the object at the second point in time t2; and determining a third point in time t3 for opening at least one door of the vehicle based on the determined collision probability.

Further examples of the present disclosure can be derived from the other features specified herein. The various examples of the present disclosures specified in this application can be advantageously combined with one another, as long as not otherwise specified.

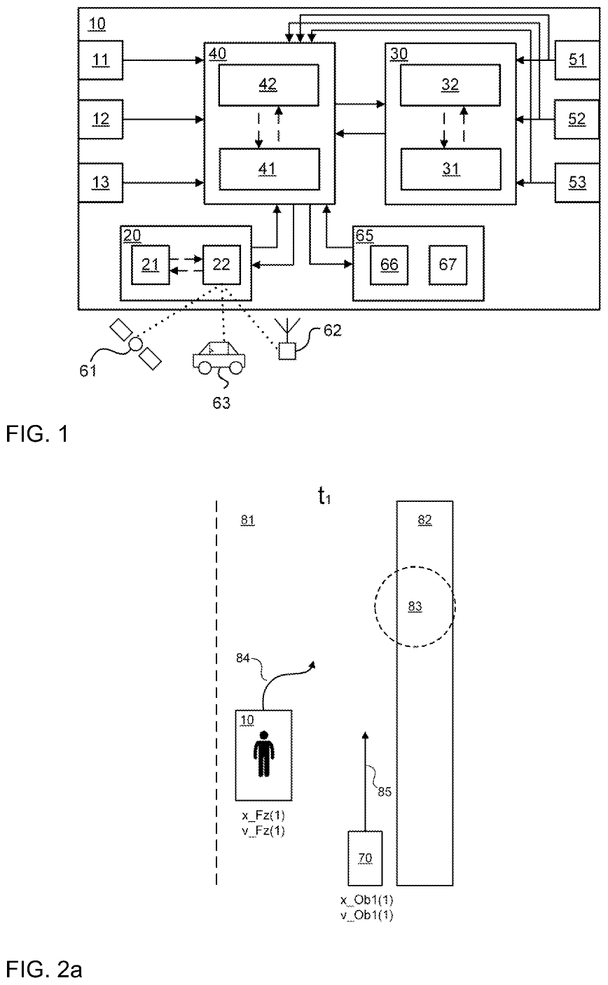

FIG. 1 shows a schematic diagram, in particular a block diagram of an exemplary self-driving motor vehicle 10 designed for passenger transportation, which includes numerous first sensors, in particular a first sensor 11, second sensor 12, and third sensor 13. The first sensors 11, 12, 13 may be configured to detect the environment of the vehicle, and in particular objects located in the environment of the vehicle, or the distances between the vehicle and these objects. The first sensors contain, for example, a lidar (sensor 11), a radar (sensor 12), and an ultrasound sensor (sensor 13). The first sensors 11, 12, 13 transmit the environment signals they record to a control unit 40 in the motor vehicle.

The motor vehicle 10 also includes numerous second sensors, in particular a fourth sensor 51, fifth sensor 52 and sixth sensor 53. The second sensors 51, 52, 53 are sensors for determining data relating to the state of the motor vehicle 10 itself, e.g. current position and movement information for the motor vehicle. The second sensors are therefore, e.g., speed sensors, acceleration sensors, tilt sensors, etc. The second sensors 51, 52, 53 transmit the vehicle state signals they record to the control unit 40 and a driving system 30 in the motor vehicle 10.

The motor vehicle 10 may also include a communication module 20 that contains a loudspeaker 21 and one or more transponders or transceivers 22. The transponders 22 may include a radio signal, WLAN, GPS, or Bluetooth transceiver, or the like. The transponder communicates with the internal memory 21 in the communication module 20, e.g. via a suitable data bus. The current position of the motor vehicle 10 can be determined by means of the transponder 22 through communication with a GPS satellite 61, and store this position in the internal memory 21. The communication module 20 communicates with the control unit 40. The communication module 20 may be configured to communicate with network servers, a base station 62, a mobile communication network, and other (self-driving) vehicles 63. By way of example, the communication module 20 is configured to communicate with the aforementioned devices via an UMTS or LTE (long term evolution) mobile communication network.

The motor vehicle 10 also includes the driving system 30, which is configured for fully autonomous driving, in particular the longitudinal and lateral control of the motor vehicle 10. The driving system 30 includes a navigation module 32, which may be configured to calculate routes between a starting point and a target destination, and to determine the maneuvers that must be executed along these routes by the motor vehicle 10. The driving system 30 also includes an internal memory 31, e.g. for map data, which communicates with the navigation module 32, e.g. via a suitable data bus. At least a portion of the second sensors 51, 52, 53 in the motor vehicle transmit their results directly to the driving system 30. The data transmitted directly to the driving system are the current position and movement information for the motor vehicle. These data are preferably obtained from speed sensors, acceleration sensors, tilt sensors, etc.

The motor vehicle 10 also includes a control unit 40 according to the present disclosure, which is configured to execute the method according to the present disclosure, as shall be explained in detail below. For this, the control unit 40 has an internal memory 41 and a CPU 42, which communicate with one another, e.g. via a suitable data bus. Moreover, the control unit is connected for communication to at least the first sensors 11, 12, 13, the second sensors 51, 52, 53, the communication module 20, and the driving system 30, e.g. via one or more respective CAN connections, one or more respective SPI connections, or other suitable data connections.

The vehicle 10 also includes an output system 65 for outputting notifications to passengers. The output system 65 contains first output means 66 for outputting notifications to passengers in the vehicle, in particular screens, loudspeakers, and other light signals (e.g. LED light sources). The output system 65 also contains second output means 67 for issuing notifications to passengers outside the vehicle 10, in particular screens, loudspeakers, and projectors for projecting notifications onto the ground, etc.

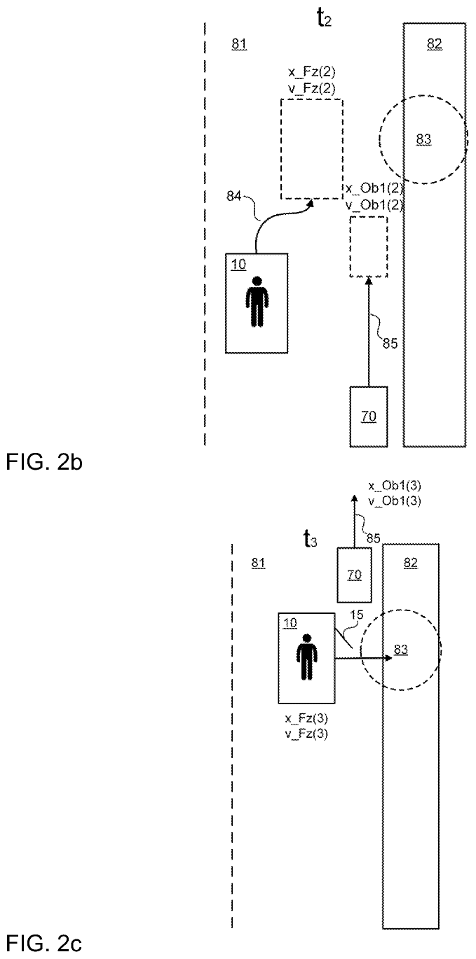

FIGS. 2(a) to 2(c) show schematic illustrations of a self-driving motor vehicle 10 according to some examples, and an additional moving object 70, at different points in time while the method is being carried out.

FIG. 2a shows the vehicle 10 according to the present disclosure, and the object 70, at a first point in time t₁. At this time, the vehicle 10 and the object 70 are each on a right-hand lane 81 in a fourlane street, which is delimited by a curb 82. A passenger is conveyed in the vehicle 10. At the first point in time t₁, the vehicle has a location x_Fz(1), which has been retrieved from GPS satellites 61 via the communication module, and a speed v_FZ(1), which is determined by the second sensors 51, 52, 53 and/or by means of the communication module and the GPS satellites 61. The object has a location x_Ob1(1) and speed v_Ob1(1) at the first point in time t₁, which are determined by the first sensors 11, 12, 13 in the vehicle 10. In addition, the vehicle 10 can use a CAM notification received from the object 70 via car-to-car communication to determine x_Ob1(1) and v_Ob1(1). At the first point in time t₁, the control unit 40 in the vehicle 10 determines a projected trajectory 84 for the vehicle 10 and a projected trajectory 85 for the object 70 based on the available measurement data and/or communication data.

As is shown in FIG. 2b, the second point in time t₂ is determined on the basis of the projected trajectory 84 for the vehicle 10, at which the vehicle 10 reaches the location x_Fz(1) of a specified stopping point 83. The specified stopping point 83 corresponds to a target destination for the passengers in the vehicle 10. The projection of the trajectory 84 for the vehicle 10 is obtained such that the speed of the vehicle 10 v_FZ(2) at the second point in time t₂ is zero, and the vehicle 10 also comes to a stop a the specified stopping point 83. A position x_Ob1(2) and speed v_Ob1(2) of the object 70 at the second point in time t₂ are also determined on the basis of the projected trajectory 85 for the object 70. As FIG. 2b shows, the moving object 70, such as a bicycle, is just behind the vehicle 10 at the second point in time t₂, with a speed vector that runs along a line between the stopping vehicle 10 and the specified stopping point 83. The object 70 is therefore in danger of colliding with a door of the vehicle 10 or a passenger getting out of the vehicle 10. This can be determined on the basis of the position and speed of the object 70 at the second point in time t₂.

Because of the existing collision probability between the object 70 and the vehicle 10 at the specified stopping point 83 at the second point in time t₂, a third point in time t₃ is determined according to the present disclosure. This third point in time t₃ is determined on the basis of the collision probability such that a door of the vehicle 10 can be safely opened, and a passenger can safely exit the vehicle 10. According to the situation shown in FIG. 2c, the third point in time t₃ follows the second point in time t₂, and the vehicle 10 comes to a standstill at a speed v_FZ(3) of zero at the specified stopping point 83 x_Fz(3). The self-driving vehicle 10 has therefore slowed down after the determination of the collision probability, such that the object 70 has enough time to pass by the vehicle 10. In particular, the object 70 may be located at a position x_Ob1(3) at the third point in time t₃ with a speed vector v_Ob1(3) leading away from the vehicle 10. The distance between the object 70 and the vehicle is therefore already greater at the third point in time t₃. The door 15 of the vehicle 10 can therefore be opened, without the threat of a collision with the object 70.

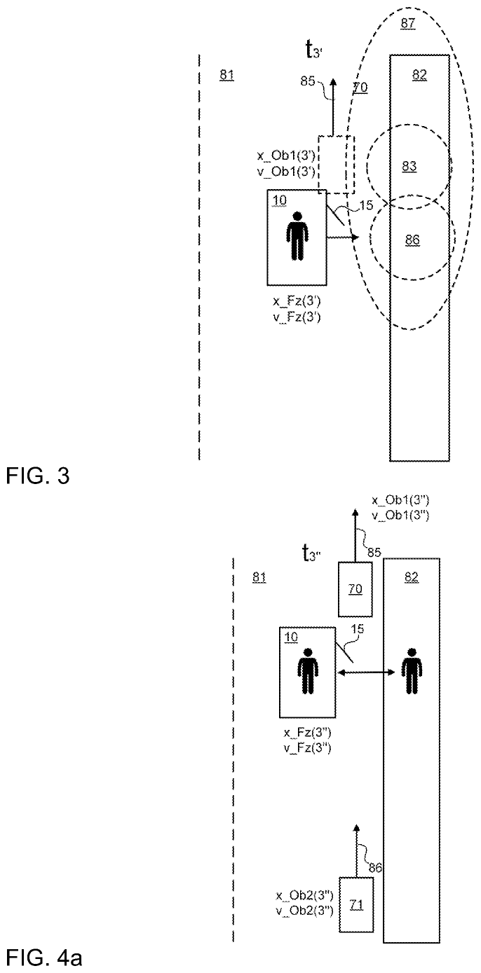

FIG. 3 shows a schematic illustration of the self-driving motor vehicle 10 and the other moving object 70 at the third point in time t₃′ according to an alternative embodiment of the method according to the present disclosure. An existing collision probability between the vehicle 10 and the object 70 is first determined, as explained in reference to FIGS. 2a and 2b. A third point in time t₃′ is likewise subsequently determined, which is the same, however, as the second point in time t₂ according to this example. An alternative stopping point 86 is also determined according to this embodiment, which lies within a tolerance range surrounding the specified stopping point 83. In particular, the alternative stopping point 86 lies along the projected trajectory 84 of the vehicle 10 before the specified stopping point 83. The vehicle 10 can therefore stop at the alternative stopping point 86 x_Fz(3′) at the third point in time t₃′, without noticeably slowing down, while the object 70 has already passed by the vehicle 10 at this point in time, and is located at a position x_Ob1(3′) that corresponds to the position x_Ob1(2), and wherein the object 70 exhibits a speed vector v_Ob1(3′) that leads away from the vehicle 10. There is therefore minimal to no risk of a collision between the object 70 and the vehicle door 15, or the passenger exiting the vehicle 10.

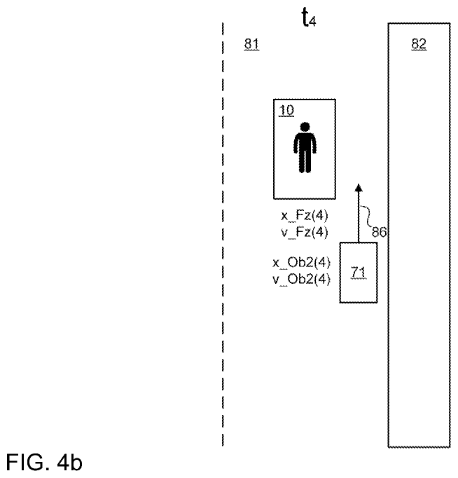

FIGS. 4a and 4b show schematic illustrations of the self-driving motor vehicle 10 according to the present disclosure, and the other moving object 70, at the third point in time t_{3″} and at a fourth point in time t₄, according to an alternative embodiment of the method according to the present disclosure. An existing collision probability between the vehicle 10 and the object 70 is first determined, as explained in reference to FIGS. 2a and 2b, and a third point in time t_{3″} is determined, at which the vehicle stops at the specified stopping point 83, which is not shown in FIG. 4 for purposes of clarity. In differing from FIG. 2, there is another passenger at the specified stopping point who wants to board the vehicle 10. These types of transfers of car sharing vehicles are known to the person skilled in the art. Furthermore, another moving object 71 is detected at the location x_Ob2(3″) in the environment of the vehicle 10 at the point in time t_{3″} and moving at a speed v_Ob2(3″). In addition, a projected trajectory of this other object 71 is determined at the point in time ^{t3″}. Based on the projected trajectory 86 of the second object 71, it is determined that there is the risk of a collision between the boarding passenger and the second object 71. Based on this risk of collision, a fourth point in time t₄ is also determined, before which the probability of a collision between the passenger and the second object 71 is extremely low. This fourth point in time t₄ is therefore determined to be the point in time at which the opened vehicle door 15 should be closed.

Furthermore, a notification is sent to the passenger outside the vehicle 10 by a second output means 67, in particular a screen or projector on the exterior of the vehicle, which notifies the passenger of the fourth point in time t₄, the necessity of boarding before the fourth point in time t₄, and of the second object 71. The passenger is therefore warned of the approaching object 71 and boards the vehicle 10 before the fourth point in time t₄, such that the vehicle door is already closed at the fourth point in time t₄ shown in FIG. 4b, before the second object 71 is within a few meters of the vehicle. The boarding procedure is therefore safely concluded, and the second object poses no danger to the passengers.

### LIST OF REFERENCE SYMBOLS

10 motor vehicle

11 first sensor

12 second sensor

13 third sensor

15 vehicle door

20 comm. module

21 memory

22 transponder

30 driving system

31 memory

32 navigation module

40 control unit

41 memory

42 CPU

51 fourth sensor

52 fifth sensor

53 sixth sensor

1-15. (canceled)

16. A method for stopping a self-driving vehicle, comprising:
determining an approach to a specified stopping point for the vehicle;
detecting at least one moving object in an environment of the vehicle;
determining a projected trajectory of the vehicle and a projected trajectory of the object at a first point in time t1;
determining a second point in time t2 for the arrival of the vehicle at the specified stopping point based on the projected trajectory of the vehicle, and a position and speed of the object at the second point in time t2 based on the projected trajectory of the object;
determining a collision probability between the object and one of (i) a door or (ii) a passenger of the vehicle at the specified stopping point based on the position and speed of the object at the second point in time t2;
determining a third point in time t3 for opening at least one door of the vehicle based on the determined collision probability; and
transmitting a command to the self-driving vehicle.

17. The method according to claim 16, further comprising determining that the collision probability exceeds a threshold value, and the third point in time t3 and the second point in time t2 differ.

18. The method according to claim 17, wherein transmitting the command comprises transmitting the command to cause the self-driving vehicle to:
adjust the speed of the vehicle; and/or
stop the vehicle at the specified stopping point at the third point in time t3.

19. The method according to claim 16, further comprising determining that the collision probability exceeds a threshold value and the third point in time t3 and second point in time t2 are identical.

20. The method according to claim 16, further comprising:
determining an alternative stopping point within a configured tolerance range surrounding the specified stopping point; and
stopping the vehicle based on the transmitted command at the alternative stopping point at the third point in time t3.

21. The method according to claim 16, further comprising determining that a distance between the vehicle and the object at the third point in time t3 exceeds a predetermined threshold value, and/or increases in a time period prior to the third point in time t3.

22. The method according to claim 16, further comprising determining a fourth point in time t4 for closing the door of the vehicle based on the projected trajectory of the moving object.

23. The method according to claim 16, further comprising:
detecting at least one further moving object in the environment of the self-driving vehicle; and
determining a fourth point in time t4 for closing the door of the vehicle based on the projected trajectory of the second object.

24. The method according to claim 16, further comprising:
determining a collision probability between the object and the door of the vehicle at the third point in time t3;
selecting one of other doors of the vehicle, based on the determined collision probabilities, and opening the selected door at the third point in time t3.

25. The method according to claim 16, further comprising:
determining a number and/or a characteristic of passengers of the vehicle; and
determining a collision probability between the object and at least one passenger of the vehicle at the specified stopping point, based on the number and/or a characteristic.

26. The method according to claim 16, further comprising:
transmitting a notification to the passenger of the vehicle,
wherein the notification comprises information regarding the third point in time t3, the alternative stopping point, and/or a moving object in the environment of the vehicle.

27. The method according to claim 26, further comprising adapting the notification based on the determined number and/or characteristic of the passenger.

28. The method according to claim 26, wherein the notification is transmitted to a screen in or on the vehicle, and/or is projected in the environment of the vehicle.

29. The method according to claim 16, wherein the passenger is located within the environment of the vehicle and is scheduled to exit the vehicle at the specified stopping point, and/or wherein the passenger is scheduled to board the vehicle at the specified stopping point.

30. A self-driving motor vehicle, comprising:
first sensors configured to detect at least one moving object in the environment of the vehicle;
second sensors configured to obtain movement data regarding the vehicle;
a communication module configured to communicate with another vehicle and/or a mobile end device;
a driving system configured for autonomous driving of motor vehicles; and
a control unit operatively coupled to the driving system, communication module, first sensors and second sensors, wherein the control unit is configured to:
determine an approach to a specified stopping point for the vehicle via first sensors;
detect at least one moving object in an environment of the vehicle via second sensors;
determine a projected trajectory of the vehicle and a projected trajectory of the object at a first point in time t1;
determine a second point in time t2 for the arrival of the vehicle at the specified stopping point based on the projected trajectory of the vehicle, and a position and speed of the object at the second point in time t2 based on the projected trajectory of the object;
determine a collision probability between the object and one of (i) a door or (ii) a passenger of the vehicle at the specified stopping point based on the position and speed of the object at the second point in time t2;
determine a third point in time t3 for opening at least one door of the vehicle based on the determined collision probability; and
transmit a command to the driving system.

31. The self-driving motor vehicle according to claim 30, wherein the control unit is configured to determine that the collision probability exceeds a threshold value, and the third point in time t3 and the second point in time t2 differ.

32. The self-driving motor vehicle according to claim 31, wherein the command is configured to cause the driving system to:
adjust the speed of the vehicle; and/or
stop the vehicle at the specified stopping point at the third point in time t3.

33. The self-driving motor vehicle according to claim 30, wherein the control unit is configured to determine that the collision probability exceeds a threshold value and the third point in time t3 and second point in time t2 are identical.

34. The self-driving motor vehicle according to claim 30, wherein the control unit is configured to:
determine an alternative stopping point within a configured tolerance range surrounding the specified stopping point; and
stop the vehicle based on the transmitted command at the alternative stopping point at the third point in time t3.

35. The self-driving motor vehicle according to claim 30, wherein the control unit is configured to determine that a distance between the vehicle and the object at the third point in time t3 exceeds a predetermined threshold value, and/or increases in a time period prior to the third point in time t3.
